(19) United States
(12) Patent Application Publication
(10) Pub. No.: US 2025/0007001 A1
(43) Pub. Date: Jan. 2, 2025

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/824,221

(22) Filed: Sep. 4, 2024

Related U.S. Application Data
(63) Continuation of application No. PCT/JP2022/010085, filed on Mar. 8, 2022.

(51) Int. Cl. H01M 10/0569; H01M 10/0525

(52) U.S. Cl. CPC H01M 10/0569; H01M 10/0525; H01M 2300/0034

(57) ABSTRACT

The purpose of the present invention is to provide a lithium secondary battery having a high energy density and an excellent cycle characteristic. The present invention relates to a lithium secondary battery including a positive electrode, a negative electrode not having a negative-electrode active material, and an electrolyte solution, in which at least a part of a surface of the negative electrode facing the positive electrode is coated with a compound including an aromatic ring to which two or more elements selected from the group consisting of N, S, and O are each independently bonded, and the electrolyte solution contains a lithium salt and a solvent represented by Formula (1).

### CROSS-REFERENCE TO RELATED APPLICATION

This application is a continuation of International Patent Application PCT/JP2022/010085, entitled, “Lithium Secondary Battery”, filed Mar. 8, 2022, the contents of which are hereby incorporated by reference in their entirety.

### BACKGROUND

### Field

The present invention relates to a lithium secondary battery.

### Description of Related Art

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which perform charge/discharge by transferring lithium ions between a positive electrode and a negative electrode are known to exhibit a high voltage and a high energy density. As typical lithium secondary batteries, lithium-ion secondary batteries (LIB) which have a positive electrode and a negative electrode having an active material capable of retaining lithium element and perform charge/discharge by delivering or receiving lithium ions between a positive-electrode active material and a negative-electrode active material are known.

For the purpose of realizing high energy density, a lithium secondary battery (lithium metal battery; LMB) that lithium metal is used as the negative-electrode active material, instead of a material into which the lithium ion can be inserted, such as a carbon material, has been developed. For example, PCT Japanese Translation Patent Publication No. 2006-500755 discloses a rechargeable battery using, as a negative electrode, an electrode based on lithium metal.

For the purpose of further improving high energy density and improving productivity, or the like, a lithium secondary battery using a negative electrode that does not have a negative-electrode active material such as the carbon material and the lithium metal has been developed. For example, PCT Japanese Translation Patent Publication No. 2019-505971 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. PCT Japanese Translation Patent Publication No. 2019-505971 discloses that such a lithium secondary battery shows the possibility of providing a lithium secondary battery which has overcome the problem due to the reactivity of the lithium metal and the problem caused during assembly process and therefore has improved performance and service life.

### SUMMARY

When the present inventors studied batteries of the prior art including those described in the PCT Japanese Translation Patent Publication No. 2006-500755 and PCT Japanese Translation Patent Publication No. 2019-505971 mentioned above, they found that at least one of energy density or cycle characteristic was insufficient.

For example, in the lithium secondary battery that includes a negative electrode containing the negative-electrode active material, due to the volume or mass occupied by the negative-electrode active material, it is difficult to sufficiently increase the energy density. In addition, even in conventional anode-free lithium secondary batteries that includes a negative electrode not having a negative-electrode active material, due to repeated charge/discharge, a dendrite-like lithium metal is likely to be formed on a surface of the negative electrode, which is likely to cause short circuiting and/or a decrease in capacity, resulting in insufficient cycle characteristic.

The present invention has been made in consideration of the aforesaid problems and a purpose is to provide a lithium secondary battery having a high energy density and excellent in cycle characteristic.

A lithium secondary battery according to one embodiment of the present invention includes a positive electrode, a negative electrode not having a negative-electrode active material, and an electrolyte solution, in which at least a part of a surface of the negative electrode facing the positive electrode is coated with a compound including an aromatic ring to which two or more elements selected from the group consisting of N, S, and O are each independently bonded, and the electrolyte solution contains a lithium salt and a solvent represented by Formula (1). In Formula (1), R¹ is an n-valent atomic group including at least one nitrogen atom and having 1 or more and 30 or less carbon atoms, R²'s are each independently a fluorine atom or an alkyl group having a fluorine atom, n represents an integer of 1 or more and 5 or less, and n pieces of [—SO₂R²] group are each bonded to R¹ by an N—S bond.

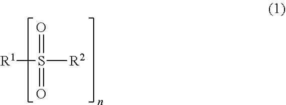

Since the negative electrode not having a negative-electrode active material is used, in the lithium secondary battery according to the above-described embodiment, the volume and mass of the entire battery are smaller and the energy density is higher in principle as compared with a lithium secondary battery having a negative-electrode active material. In the lithium secondary battery according to the above-described embodiment, a lithium metal is deposited on a surface of the negative electrode, and charge/discharge are performed by electrolytically dissolving the deposited lithium metal.

In addition, since the negative electrode in which at least a part of the surface facing the positive electrode is coated with a compound including an aromatic ring to which two or more elements selected from the group consisting of N, S, and O are each independently bonded is used, it is presumed that the lithium secondary battery according to the above-described embodiment has excellent cycle characteristic by compensating for the deposition and dissolution of lithium metal on the surface of the negative electrode.

Further, the present inventors have found that, in the aforesaid lithium secondary battery, since the electrolyte solution contains the solvent represented by Formula (1) and the lithium salt in addition to the aforesaid configuration, both high energy density and excellent cycle characteristic can be achieved. The factor is not clear, but since the compound represented by Formula (1) is contained in the electrolyte solution, the deterioration of the positive electrode material is suppressed, so that it is presumed to be due to at least one factor of that reversibility of lithium metal deposition and dissolution on the negative electrode surface during repeated charge/discharge of the battery is improved, that a solid electrolyte interphase layer (which will hereinafter be called “SEI layer”) is easily formed on the surface of the negative electrode, or that the SEI layer is of better quality. The factor is however not limited to the above.

In the lithium secondary battery according to one embodiment of the present invention, it is preferable that, in R¹, a nitrogen atom bonded to the [—SO₂R²] group is bonded to two carbon atoms. In such a mode, reactivity and the like of the [—SO₂R²] group tend to be more preferable, and the lithium secondary battery tends to have even more excellent cycle characteristic.

In the lithium secondary battery according to one embodiment of the present invention, R¹ may include a chain structure including at least one nitrogen atom.

In the lithium secondary battery according to one embodiment of the present invention, R¹ may include a cyclic structure including at least one nitrogen atom.

In the lithium secondary battery according to one embodiment of the present invention, it is preferable that R²'s are each independently a fluorine atom or an alkyl group in which a ratio (F/(F+H)) of the number (F) of fluorine atoms to the total number (F+H) of fluorine atoms and hydrogen atoms is 0.70 or more and 1.0 or less. In such a mode, reactivity and the like of the [—SO₂R²] group tend to be more preferable, and the lithium secondary battery tends to have even more excellent cycle characteristic.

In the lithium secondary battery according to one embodiment of the present invention, it is preferable that R²'s are each independently a fluorine atom or a trifluoromethyl group. In such a mode, the lithium secondary battery tends to have even more excellent cycle characteristic.

In the lithium secondary battery according to one embodiment of the present invention, it is preferable that the electrolyte solution further contains an ether compound not having a fluorine atom or a carbonyl compound not having a fluorine atom. Such a compound tends to further improve the cycle characteristic of the lithium secondary battery synergistically with the compound represented by Formula (1).

In the lithium secondary battery according to one embodiment of the present invention, it is preferable that the electrolyte solution further contains a chain fluorine compound represented by Formula (A) or Formula (B). Such a compound tends to further improve the cycle characteristic of the lithium secondary battery synergistically with the compound represented by Formula (1). In Formula (A), R⁶ is an alkyl group which may include an ether bond, R⁷ is a fluorine-substituted alkylene group, and R⁸ is an alkyl group which may include an ether bond. In Formula (B), R⁹ is a fluorine-substituted alkyl group, R¹⁰ is an alkylene group which may include an ether bond, and R¹¹ is an alkyl group which may be substituted with fluorine.

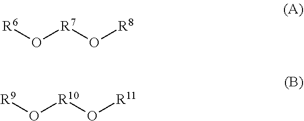

In the lithium secondary battery according to one embodiment of the present invention, it is preferable that the lithium salt includes at least LiN(SO₂F)₂. In such a mode, the lithium secondary battery tends to have even more excellent energy density and cycle characteristic.

In the lithium secondary battery according to one embodiment of the present invention, it is preferable that, in the compound coating the negative electrode, one or more nitrogen atoms are bonded to the aromatic ring. In such a mode, strength of interaction between a negative electrode coating agent and lithium ions is improved further, and thus the cycle characteristic of the lithium secondary battery tends to be even more excellent.

In the lithium secondary battery according to one embodiment of the present invention, it is preferable that the compound coating the negative electrode is at least one selected from the group consisting of benzotriazole, benzimidazole, benzimidazolethiol, benzoxazole, benzothiazolethiol, benzothiazole, mercaptobenzothiazole, polyimide, polyimidazole, and derivatives of these compounds. In such a mode, electrical connection between the negative electrode and the lithium ions with which the negative electrode coating agent is coordinated is improved further in the lithium secondary battery, and thus the cycle characteristic of the lithium secondary battery tends to be improved further.

In the lithium secondary battery according to one embodiment of the present invention, it is preferable that the positive electrode contains a positive-electrode active material and a lithium-containing compound which causes an oxidation reaction and substantially does not cause a reduction reaction in a charge/discharge potential range of the positive-electrode active material. In such a mode, the lithium secondary battery tends to have even more excellent cycle characteristic.

The present invention makes it possible to provide a lithium secondary battery having a high energy density and an excellent cycle characteristic.

### BRIEF DESCRIPTION OF DRAWINGS

FIG. 1 is a schematic cross-sectional view of a lithium secondary battery according to the embodiment of the present invention.

FIG. 2 is a schematic cross-sectional view of the use of the lithium secondary battery according to the embodiment of the present invention.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. The dimensional ratios shown in the drawings are not limited to the depicted ratios.

### Present Embodiment

### (Lithium Secondary Battery)

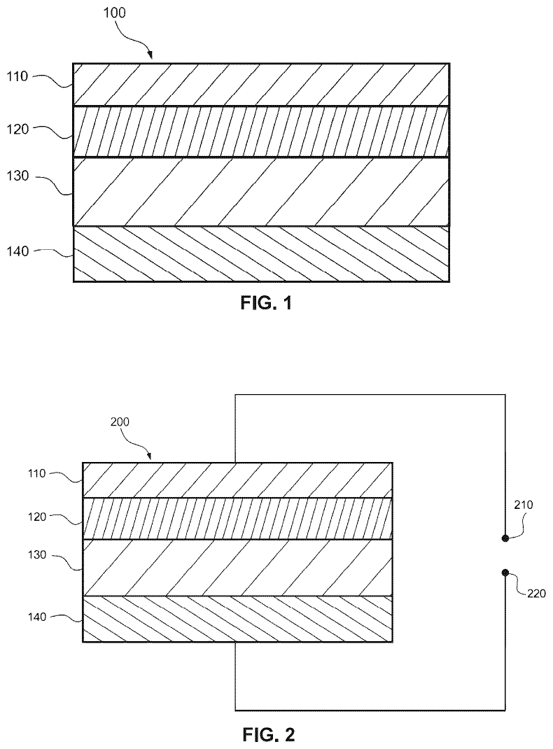

FIG. 1 is a schematic cross-sectional view of the lithium secondary battery according to the present embodiment. As illustrated in FIG. 1, a lithium secondary battery 100 according to the present embodiment includes a positive electrode 120, a negative electrode 140 not having a negative-electrode active material, a separator 130 placed between the positive electrode 120 and the negative electrode 140, and an electrolyte solution that is not illustrated in FIG. 1. The positive electrode 120 has a positive electrode current collector 110 on the surface thereof opposite to the surface facing the separator 130.

Hereinafter, each configuration of the lithium secondary battery 100 will be described.

### (Negative Electrode)

The negative electrode 140 does not have a negative-electrode active material. The “negative-electrode active material” as used herein is a substance that causes an electrode reaction, that is, an oxidation reaction and a reduction reaction at the negative electrode. Specifically, examples of the negative-electrode active material in the present embodiment include lithium metal and a host material for a lithium element (lithium ions or lithium metal). The host material for the lithium element means a material provided to retain the lithium ions or the lithium metal in the negative electrode. Such a retaining mechanism is not particularly limited, and examples thereof include intercalation, alloying, and occlusion of metal clusters. Intercalation is typically used.

In the lithium secondary battery according to the present embodiment, because the negative electrode does not have a negative-electrode active material before initial charge of the battery, charge/discharge are performed by depositing lithium metal on the negative electrode and electrolytically dissolving the deposited lithium metal. Therefore, in the lithium secondary battery according to the present embodiment, an occupation volume of the negative-electrode active material and a mass of the negative-electrode active material decreases as compared with a lithium secondary battery containing the negative-electrode active material, and the volume and mass of the entire battery are small, so that the energy density is high in principle.

In the lithium secondary battery 100 according to the present embodiment, the negative electrode 140 does not have a negative-electrode active material before initial charge of the battery, a lithium metal is deposited on the negative electrode when the battery is charged, and the deposited lithium metal is electrolytically dissolved when the battery is discharged. Therefore, in the lithium secondary battery according to the present embodiment, the negative electrode acts as a negative electrode current collector. That is, in other words, the lithium secondary battery according to the present embodiment includes a negative electrode consisting of a negative electrode current collector not having a negative-electrode active material.

The phrase “lithium metal being deposited on the negative electrode as used” herein means the lithium metal is deposited on at least one surface of the surface of the negative electrode coated with the negative electrode coating agent or the surface of the solid electrolyte interphase layer (SEI layer) formed on the surface of the negative electrode, which will be described later. Therefore, in the lithium secondary battery 100, the lithium metal may be deposited on, for example, a surface of the negative electrode 140 coated with the negative electrode coating agent (an interface between the negative electrode 140 and the separator 130).

In a case where the lithium secondary battery 100 according to the present embodiment is compared with a lithium ion battery (LIB) and a lithium metal battery (LMB), the following points are different.

In the lithium ion battery (LIB), a negative electrode has a host material for a lithium element (lithium ions or lithium metal), this material is filled with the lithium element when the battery is charged, and the host material releases the lithium element, thereby discharging the battery. The LIB is different from the lithium secondary battery 100 according to the present embodiment in that the negative electrode has the host material for the lithium element.

The lithium metal battery (LMB) is produced by using, as a negative electrode, an electrode having lithium metal on its surface or a single lithium metal. That is, the LMB is different from the lithium secondary battery 100 according to the present embodiment in that the negative electrode has the lithium metal, that is the negative-electrode active material, immediately after assembling the battery, that is, before initial charge of the battery. The LMB uses the electrode containing lithium metal having high flammability and reactivity in its production. However, because the lithium secondary battery 100 according to the present embodiment uses the negative electrode not having lithium metal, the lithium secondary battery 100 according to the present embodiment is more safe and productive.

The negative electrode “not having a negative-electrode active material” as used herein means the negative electrode 140 does not have the negative-electrode active material or does not substantially have the negative-electrode active material. The fact that the negative electrode 140 does not substantially have the negative-electrode active material means the content of the negative-electrode active material in the negative electrode 140 is 10% by mass or less based on the total amount of the negative electrode. The content of the negative-electrode active material in the negative electrode is preferably 5.0% by mass or less and it may be 1.0% by mass or less, 0.1% by mass or less, or 0.0% by mass or less, each based on the total amount of the negative electrode 140. Since the negative electrode 140 does not have the negative-electrode active material or the content of the negative-electrode active material in the negative electrode 140 falls within the aforesaid range, the energy density of the lithium secondary battery 100 is high.

The phrase “before initial charge” of the battery as used herein means a state from the time when the battery is assembled to the time when the battery is first charged. In addition, the phrase “at the end of discharge” of the battery means a state in which the battery voltage is 1.0 V or more and 3.8 V or less, preferably 1.0 V or more and 3.0 V or less.

The phrase “lithium secondary battery including a negative electrode not having a negative-electrode active material” as used herein means the negative electrode 140 does not have the negative-electrode active material before initial charge of the battery. Therefore, the phrase “negative electrode not having a negative-electrode active material” may be replaced by “negative electrode not having a negative-electrode active material before initial charge of the battery”, “negative electrode that does not have a negative-electrode active material other than lithium metal regardless of the state of charging of the battery and does not have the lithium metal before initial charge”, “negative electrode current collector not having lithium metal before initial charge”, or the like. In addition, the phrase “lithium secondary battery including a negative electrode not having a negative-electrode active material” may be replaced by an anode-free lithium battery, a zero-anode lithium battery, or an anode-less lithium battery.

In the negative electrode 140 according to the present embodiment, regardless of the state of charging of the battery, the content of the negative-electrode active material other than lithium metal may be 10% by mass or less based on the total amount of the negative electrode, preferably 5.0% by mass or less, and may be 1.0% by mass or less, 0.1% by mass or less, 0.0% by mass or less, or 0% by mass.

In addition, in the negative electrode 140 according to the present embodiment, the content of lithium metal before initial charge may be 10% by mass or less based on the total amount of the negative electrode, preferably 5.0% by mass or less, and may be 1.0% by mass or less, 0.1% by mass or less, 0.0% by mass or less, or 0% by mass.

In the lithium secondary battery 100 according to the present embodiment, in a case where the battery voltage is 1.0 V or more and 3.5 V or less, the content of lithium metal may be 10% by mass or less based on the total amount of the negative electrode 140 (preferably 5.0% by mass or less, and may be 1.0% by mass or less); in a case where the battery voltage is 1.0 V or more and 3.0 V or less, the content of lithium metal may be 10% by mass or less based on the total amount of the negative electrode 140 (preferably 5.0% by mass or less, and may be 1.0% by mass or less); or in a case where the battery voltage is 1.0 V or more and 2.5 V or less, the content of lithium metal may be 10% by mass or less based on the total amount of the negative electrode 140 (preferably 5.0% by mass or less, and may be 1.0% by mass or less).

In the lithium secondary battery 100 according to the present embodiment, a ratio M_{3.0}/M_{4.2} of a mass M_{3.0} of lithium metal deposited on the negative electrode in a state in which the battery voltage is 3.0 V to a mass M_{4.2} of lithium metal deposited on the negative electrode in a state in which the battery voltage is 4.2 V is preferably 40% or less, more preferably 38% or less, and still more preferably 35% or less. The ratio M_{3.0}/M_{4.2} may be 1.0% or more, 2.0% or more, 3.0% or more, or 4.0% or more.

Examples of the negative-electrode active material according to the present embodiment include lithium metal, alloys containing lithium metal, carbon-based materials, metal oxides, metals alloyed with lithium, and alloys containing the metals. The carbon-based material is not particularly limited, and examples thereof include graphene, graphite, hard carbon, mesoporous carbon, carbon nanotube, and carbon nanohorn. The metal oxide is not particularly limited, and examples thereof include titanium oxide-based compounds, tin oxide-based compounds, and cobalt oxide-based compounds. Examples of the aforesaid metals alloyed with lithium include silicon, germanium, tin, lead, aluminum, and gallium.

The negative electrode 140 according to the present embodiment is not particularly limited insofar as it does not have a negative-electrode active material and can be used as a current collector. Examples thereof include at least one selected from the group consisting of metals such as Cu, Ni, Ti, Fe, and other metals that do not react with Li, alloys of these metals, and stainless steel (SUS), and preferred examples thereof include at least one selected from the group consisting of Cu, Ni, alloys of these metals, and stainless steel (SUS). When this negative electrode is used, the energy density and the productivity of the battery tend to be improved further. When an SUS is used as the negative electrode, a variety of conventionally known SUSs can be used as its kind. One or more of the negative electrode materials may be used alone or in combination. The term “metal that does not react with Li” as used herein means a metal which does not form an alloy under the operation conditions of the lithium secondary battery, reacting with a lithium ion or a lithium metal.

The capacity of the negative electrode 140 is sufficiently small relative to the capacity of the positive electrode 120 and it may be, for example, 20% or less, 15% or less, 10% or less, or 5% or less. Each capacity of the positive electrode 120 and the negative electrode 140 can be measured by a conventionally known method.

The average thickness of the negative electrode 140 is preferably 4 μm or more and 20 μm or less, more preferably 5 μm or more and 18 μm or less, and still more preferably 6 μm or more and 15 μm or less. In such a mode, since the occupation volume of the negative electrode 140 in the lithium secondary battery 100 decreases, the lithium secondary battery 100 has a more improved energy density.

### (Negative Electrode Coating Agent)

Since the lithium secondary battery 100 includes the negative electrode 140 not having a negative-electrode active material, the energy density is high. However, the present inventors have found that, in a case where the negative electrode not having a negative-electrode active material is simply used, a dendrite-like lithium metal is deposited on the negative electrode due to charge/discharge of the battery, the battery is short-circuited, and in a case where the deposited dendrite-like lithium metal is dissolved, a root portion of the dendrite-like lithium metal is eluted, and a part of the lithium metal is peeled off from the negative electrode to be in an inactive state, thereby causing a problem in that the capacity of the battery is reduced. In the lithium secondary battery 100, since the specific compound is applied onto the surface of the negative electrode 140, the growth of the lithium metal deposited on the negative electrode in a dendrite is suppressed.

In the lithium secondary battery 100, at least a part of a surface of the negative electrode 140 facing the positive electrode 120 (and the separator 130) is coated with a compound (which will hereinafter be called as the term “negative electrode coating agent”) including an aromatic ring to which two or more elements selected from the group consisting of N, S, and O are each independently bonded. It is presumed that the negative electrode coating agent is held on the negative electrode 140 by coordinately bonded to a metal atom constituting the negative electrode 140 in at least one element selected from the group consisting of N, S, and O. Therefore, it is presumed that the negative electrode coating agent does not separate and/or decompose even in a case where the battery is repeatedly charged and discharged. The phrase “at least a part of the surface facing the positive electrode” for the portion coated with the negative electrode coating agent means that the negative electrode coating agent is coated on at least a part of the surface of the negative electrode, which is a portion where lithium metal can deposit and dissolve. Therefore, it is not necessary that the negative electrode coating agent is coated on “at least a part of the surface facing the positive electrode” with physical precision.

It is considered that the negative electrode coating agent coordinated to the metal atom constituting the negative electrode interacts with the lithium ion present on the surface of the negative electrode in at least one element selected from the group consisting of N, S, and O. That is, since the negative electrode coating agent can be a starting point or a scaffold of the deposition reaction of the lithium metal on the surface of the negative electrode, it is presumed that, in a case where the negative electrode 140 coated with the negative electrode coating agent is used, an uneven deposition reaction of the lithium metal on the surface thereof can be suppressed, and the growth of lithium metal deposited on the negative electrode in a dendrite can be suppressed.

Therefore, the negative electrode coating agent is not particularly limited insofar as it is a compound including an aromatic ring to which two or more elements selected from the group consisting of N, S, and O are each independently bonded, that is, a compound having a structure in which two or more of N, S, and O are independently bonded to an aromatic ring. Examples of the aromatic ring include aromatic hydrocarbons such as benzene, naphthalene, azulene, anthracene, and pyrene, and heteroaromatic compounds such as furan, thiophene, pyrrole, imidazole, pyrazole, pyridine, pyridazine, pyrimidine, and pyrazine. Among these, an aromatic hydrocarbon is preferable, benzene or naphthalene is more preferable, and benzene is still more preferable.

In the negative electrode coating agent, it is preferable that one or more nitrogen atoms are bonded to the aromatic ring. Further, it is more preferable that the negative electrode coating agent is a compound having a structure in which a nitrogen atom is bonded to the aromatic ring, and in addition to the nitrogen atom, one or more elements selected from the group consisting of N, S, and O are each independently bonded to the aromatic ring. In a case where the compound in which a nitrogen atom is bonded to the aromatic ring is used as the negative electrode coating agent in this way, the cycle characteristic of the battery tends to be improved further.

The negative electrode coating agent is preferably at least one selected from the group consisting of a compound represented by Formula (C) and a derivative thereof. In such a mode, the cycle characteristic of the battery tends to be improved further.

In the formula, X¹ represents any one of C to which X³ is bonded or N; X² represents any one of N to which X⁴ is bonded, S, or O; X³ represents —R¹², —NR¹²₂, —OR¹², or —SR¹²; X⁴ represents any one of —R¹³, —CO—X, —CS—NX₂, —SO₂—X, —SiX₃, or —OX; R¹² represents a hydrogen atom, an unsubstituted monovalent hydrocarbon group, or a pyridyl group; R¹³ represents a hydrogen atom or a monovalent hydrocarbon group which may be substituted; and X represents any monovalent substituent.

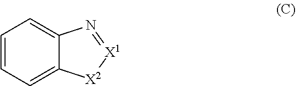

In Formula (C), X¹ represents any one of C to which X³ is bonded or N. The C to which X³ is bonded is C—R¹², C—NR¹²₂, C—OR¹², or C—SR¹², and in this case, the leftmost C is bonded to N and X². R¹² is a hydrogen atom, an unsubstituted monovalent hydrocarbon group, or a pyridyl group. The unsubstituted monovalent hydrocarbon group in R¹² is not particularly limited, examples thereof include saturated or unsaturated linear or branched hydrocarbon groups having 1 to 10 carbon atoms, and a methyl group or an ethyl group is preferable. The pyridyl group in R¹² is not particularly limited, examples thereof include a 2-pyridyl group, a 3-pyridyl group, and a 4-pyridyl group, and a 2-pyridyl group is preferable. Examples of a preferred aspect of X¹ include N, C—H, C—SH, C—C₅H₄N, and C—CH₃.

In Formula (C), X² represents any one of N to which X⁴ is bonded, S, or O. The N to which X⁴ is bonded is N—R¹³, N—CO—X, N—CS—NX₂, N—SO₂—X, N—SiX₃, or N—OX, and in this case, the leftmost N is bonded to C and X¹ of the benzene ring. Here, R¹³ is a hydrogen atom or a monovalent hydrocarbon group which may be substituted, and X is any monovalent substituent.

The monovalent hydrocarbon group which may be substituted in R¹³ is not particularly limited, and examples thereof include saturated or unsaturated linear or branched hydrocarbon group having 1 to 10 carbon atoms, which may be substituted. A substituent in the monovalent hydrocarbon group which may be substituted is not particularly limited, and examples thereof include a nitrile group, a halogen group, a silyl group, a hydroxy group, an alkoxy group, an aryl group, and an aryloxy group. X is not particularly limited, and examples thereof include a hydrogen atom, an unsaturated saturated or unsaturated linear or branched hydrocarbon group having 1 to 10 carbon atoms, an amino group which may be substituted, an aryl group which may be substituted, a heteroaromatic group which may be substituted, an alkylcarbonyl group, and an arylcarbonyl group. X may be a substituent having no active hydrogen.

Examples of a preferred aspect of X² include S, O, N—H, N—CH₂—C(CH), N—CH₂—Cl, N—CH₂—Si(CH₃)₃, N—CH₂—O—CH₃, N—CH₂—C(═CH₂)—CH₃, N—CH₃, N—CS—NH—C₃HC₅, N—CS—NH—C₃H₂NS, N—CS—NH—CH₂—C₆H₅, N—CS—NC₄H₈, N—CO—CH₃, N—CO—C₆H₅, N—CO—C₅H₄N, N—CO—NH₂, N—CO—C₆H₄Cl, N—CO—C₁₀H₇, N—CO—NH—C₆H₅, N—SO₂—CH₃, N—SO₂—C₆H₅, N—SO₂—C₃H₂N₂(CH₃), N—SO₂—C₄H₃S, N—SO₂—C₅H₄N, and N—O—CO—C₆H₅.

The compound represented by Formula (C) may be a polymer such as a dimer or a trimer of Tris-(1-benzotriazolyl) methane or 2,6-bis [(1H-benzotriazole-1-yl)methyl]-4-methylphenol, but the compound represented by Formula (C) is preferably a monomer.

Among them, the negative electrode coating agent is more preferably at least one selected from the group consisting of benzotriazole, benzimidazole, benzimidazolethiol, benzoxazole, benzothiazolethiol, benzothiazole, mercaptobenzothiazole, and derivatives thereof. In such a mode, electrical connection between the negative electrode and the lithium ions with which the negative electrode coating agent is coordinated is improved further, and thus the cycle characteristic of the battery tends to be improved further.

Among them, from a similar standpoint, the negative electrode coating agent is still more preferably at least one selected from the group consisting of benzotriazole, benzimidazole, benzoxazole, mercaptobenzothiazole, and derivatives thereof.

Further, as the negative electrode coating agent, it is also preferable to use at least one selected from the group consisting of a polymer including a structural unit derived from the compound represented by Formula (C) described above, a polyimide, and a polyimidazole, and derivatives thereof. In such a mode, the cycle characteristic of the battery tends to be improved further. From a similar standpoint, as the polymer including the structural unit derived from the compound represented by Formula (C) described above, polybenzimidazole or derivatives thereof are preferably used.

The derivative of the compound represented by Formula (C) described above or the derivative of benzotriazole, benzimidazole, benzimidazolethiol, benzoxazole, benzothiazolethiol, benzothiazole, mercaptobenzothiazole, the polymer including the structural unit derived from the compound represented by Formula (C) described above, polyimide, and polyimidazole is not particularly limited insofar as it is a compound derived from these compounds, in which a substituent is bonded to a part of these compounds. Examples of such a derivative include a compound in which one or more substituents selected from the group consisting of a hydrocarbon group which may have a substituent, an amino group which may have a substituent, a carboxy group, a sulfo group, a halogen group, and a silyl group are each independently bonded to the aromatic ring of the aforesaid compound. Further, such a derivative is preferably a derivative having a fluorine atom.

Specific examples of the negative electrode coating agent include 1H-benzotriazole, 5-methyl-1H-benzotriazole, 4-methyl-1H-benzotriazole, 1-benzoyl-1H-benzotriazole, 1-(2-pyridylcarbonyl)benzotriazole, 1-acetyl-1H-benzotriazole, 5-amino-1H-benzotriazole, 2-mercaptobenzothiazole, 6-amino-2-mercaptobenzothiazole, benzimidazole, 2-(2-pyridyl)benzimidazole, benzoxazole, 2-methylbenzoxazole, benzotriazole-5-carboxylic acid, benzotriazole-1-carboxamide, N-(2-propenyl)-1H-benzotriazole-1-carbothioamide, 1-(methoxymethyl)-1H-benzotriazole, 1-(2-thienylsulfonyl)-1H-benzotriazole, 1-(3-pyridinylsulfonyl)-1H-benzotriazole, 5-(trifluoromethyl)-1H-1,2,3-benzotriazole, bis(1-benzotriazolyl) methanethione, benzotriazol-1-ylpyrrolidin-1-ylmethanethione, 1-(1-naphthylcarbonyl)-1H-benzotriazole, 1-(2-methyl-allyl)-1H-benzotriazole, 1-(benzoyloxy)-1H-1,2,3-benzotriazole, N-phenyl-1H-1,2,3-benzotriazole-1-carboxamide, and 2,6-bis [(1H-benzotriazole-1-yl)methyl]-4-methylphenol.

Among them, as the negative electrode coating agent, 1H-benzotriazole, 5-methyl-1H-benzotriazole, 4-methyl-1H-benzotriazole, 1-benzoyl-1H-benzotriazole, 1-(2-pyridylcarbonyl)benzotriazole, 2-mercaptobenzothiazole, 6-amino-2-mercaptobenzothiazole, benzimidazole, 2-(2-pyridyl)benzimidazole, 2-methylbenzoxazole, 1-(methoxymethyl)-1H-benzotriazole, 1-(1-naphthylcarbonyl)-1H-benzotriazole, 1-(2-methyl-allyl)-1H-benzotriazole, 1-(benzoyloxy)-1H-1,2,3-benzotriazole, or 2,6-bis [(1H-benzotriazole-1-yl)methyl]-4-methylphenol is preferable, and 1H-benzotriazole is more preferable.

The negative electrode coating agent is applied onto at least a part of the surface of the negative electrode 140 facing the positive electrode 120. The expression that the negative electrode coating agent is “applied onto at least a part of the surface of the negative electrode” means that the surface of the negative electrode has the negative electrode coating material in an area ratio of 10% or more. The negative electrode 140 has the negative electrode coating agent in an area ratio of preferably 20% or more, 30% or more, 40% or more, or 50% or more, more preferably 70% or more, and still more preferably 80% or more.

A method of coating the surface of the negative electrode 140 with the negative electrode coating agent will be described later in the method of manufacturing the lithium secondary battery. In addition, the aforesaid negative electrode coating agent may be used alone or in combination of two or more thereof.

### (Electrolyte Solution)

The electrolyte solution contains an electrolyte and a solvent. It is a solution having ionic conductivity and serves as a conductive path of a lithium ion. The separator 130 may be impregnated with the electrolyte solution or the electrolyte solution may be encapsulated with a stacked body of the positive electrode 120, the separator 130, and the negative electrode 140 inside a hermetically sealing container.

The electrolyte solution according to the present embodiment contains a lithium salt and a solvent represented by Formula (1). In Formula (1), R¹ is an n-valent atomic group including at least one nitrogen atom and having 1 or more and 30 or less carbon atoms, R²'s are each independently a fluorine atom or an alkyl group having a fluorine atom, n represents an integer of 1 or more and 5 or less, and n pieces of [—SO₂R²] group are each bonded to R¹ by an N—S bond.

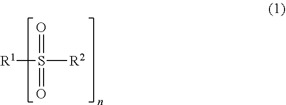

In an anode-free lithium secondary battery containing an electrolyte solution, it is necessary to suppress an increase in internal resistance due to side reactions in the positive-electrode active material, the negative electrode, or the like, and deterioration of each member. In addition, in a case where such a lithium secondary battery is charged and discharged, the solid electrolyte interphase layer (SEI layer) formed on the surface of the negative electrode or the like plays a role of further decomposing components in the electrolyte solution in the battery, thereby suppressing the irreversible reduction of lithium ions and the generation of gas. Therefore, it is very important to prevent the deterioration due to the side reactions in the positive-electrode active material, the negative electrode, or the like, and to promote the formation of the high-quality SEI layer in order to improve the performance of the anode-free lithium secondary battery.

The compound represented by Formula (1) described above has low reactivity with the positive electrode material, and can prevent chain-like cracks in the positive-electrode active material. In addition, since the compound represented by Formula (1) described above has the [—SO₂R²] group and each [—SO₂R²] group is bonded to R¹ by an N—S bond, in the lithium secondary battery according to the present embodiment, the SEI layer containing fluorine (F), sulfur(S), nitrogen (N), and the like is likely to be formed during charging. It is presumed that such an SEI layer suppresses the deterioration of the electrolyte solution in the negative electrode and/or the generation of gas, and further improves reversibility with respect to deposition and dissolution of lithium metal formed on the negative electrode.

As a result, it is presumed that the lithium secondary battery according to the present embodiment can suppress the deterioration of each component even in a case where charge/discharge are repeated, and has even more excellent cycle characteristic.

Further, in the lithium secondary battery according to the present embodiment, as described above, the negative electrode coating agent is coated on at least a part of the surface of the negative electrode facing the positive electrode. As a result, it is presumed that the effects of the electrolyte solution described above are combined to further improve the energy density and the cycle characteristic of the lithium secondary battery, but the cause is not limited thereto.

Hereinafter, the compound represented by Formula (1) as used herein is also simply referred to as “compound of Formula (1)”.

In addition, the phrase “R²'s being each independently” means that, in a case where n is 2 or more, that is, in a case of a plurality of [—SO₂R²] groups, R²'s in the plurality of [—SO₂R²] groups are each independently selected. That is, in the present specification, the structures of R²'s in the plurality of [—SO₂R²] groups may be the same or different from each other.

Further, in a case where n in the compound of Formula (1) is 2 or more, one or two [—SO₂R²] groups may be bonded to one nitrogen atom.

It is also possible to interpret that the compound of Formula (1) is a compound in which, in a compound having 1 or more and 30 or less carbon atoms, at least one carbon atom is substituted with a divalent [—N(SO₂R²)—] group, a monovalent [—N(SO₂R²)₂] group, or the like, and the substitution is performed in 1 or more and 5 or less carbon atoms.

In Formula (1), an element constituting the atomic group of R¹ is not particularly limited, and is, for example, H, C, N, O, F, B, S, P, AI, Si, Cl, As, Bi, or the like. From the standpoint of further improving the cycle characteristic of the lithium secondary battery according to the present embodiment, the element constituting the atomic group of R¹ is preferably selected from the group consisting of H, C, N, O, F, B, S, P, and Si; and more preferably selected from the group consisting of H, C, N, O, and F.

In Formula (1), it is preferable that the nitrogen atom of R¹, bonded to the [—SO₂R²] group, is bonded to two carbon atoms. That is, it is preferable that the nitrogen atom bonded to the [—SO₂R²] group does not have active hydrogen. With the compound of Formula (1), having such a structure, the reactivity or the like of the [—SO₂R²] group is more preferable, and the lithium secondary battery tends to have even more excellent cycle characteristic.

In Formula (1), the number of carbon atoms in R¹ may be, for example, 1 or more and 15 or less. In addition, from the standpoint of improving the stability of the electrolyte solution and further improving the cycle characteristic of the battery, the number of carbon atoms in R¹ is preferably 2 or more and 12 or less, more preferably 3 or more and 10 or less, still more preferably 4 or more and 9 or less, and even more preferably 5 or more and 8 or less.

A molecular weight of the compound of Formula (1) contained in the electrolyte solution according to the present embodiment is not particularly limited, and for example, it is 100 or more and 1000 or less. From the standpoint of further improving the cycle characteristic of the lithium secondary battery, the molecular weight of the compound of Formula (1) is preferably 120 or more and 900 or less, more preferably 160 or more and 700 or less, and still more preferably 180 or more and 500 or less.

In one mode of the compound of Formula (1), R¹ includes a chain structure including at least one nitrogen atom. In such a mode, the cycle characteristic of the battery tends to be even more excellent.

In addition, the phrase “chain structure including at least one nitrogen atom” as used herein means a structure in which a carbon atom group including at least one nitrogen atom is bonded in a chain manner.

In one mode of the compound of Formula (1), R¹ includes a cyclic structure including at least one nitrogen atom. In such a mode, the cycle characteristic of the battery tends to be even more excellent.

In addition, the phrase “cyclic structure including at least one nitrogen atom” as used herein means a structure in which a carbon atom group including at least one nitrogen atom is bonded in a cyclic manner.

In one mode, the compound of Formula (1) is a compound represented by Formula (2) or (3). From the standpoint of further improving the cycle characteristic of the battery, in one mode, it is preferable that the compound of Formula (1) is a compound represented by Formula (2).

Here, in Formula (2), R³'s are each independently an alkyl group having 1 or more carbon atoms, in which a hydrogen atom may be substituted with a fluorine atom. In addition, the number of carbon atoms in R³ is preferably 2 or more. In Formula (3), R⁴'s are each independently an alkyl group having 1 or more carbon atoms, in which a hydrogen atom may be substituted with a fluorine atom, and R⁵ is an alkenyl group having 1 or more carbon atoms, in which a hydrogen atom may be substituted with a fluorine. The upper limit of the number of carbon atoms in R³, R⁴, and R⁵ is not particularly limited, and is independently, for example, 5, 4, or 3. In Formulae (2) and (3), R² has the same meaning as R² in Formula (1).

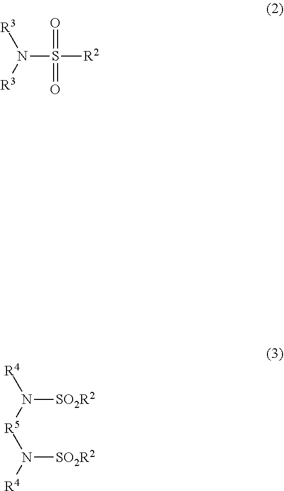

In one mode of the compound of Formula (1), R¹ includes a cycloalkane structure including at least one nitrogen atom (a ring structure consisting of at least one nitrogen atom and carbon atoms). In such a mode, the cycle characteristic of the battery tends to be even more excellent. From a similar standpoint, the number of carbon atoms in the cycloalkane structure is preferably 3 or more and 8 or less, and more preferably 4 or more and 6 or less. In such a mode, the number of nitrogen atoms and the number of [—SO₂R²] groups bonded to the nitrogen atom are preferably 1 or 2. In addition, the number of nitrogen in the cycloalkane structure is preferably 1 or 2.

In one mode of the compound of Formula (1), R¹ includes an aromatic ring structure including at least one nitrogen atom (an aromatic ring structure consisting of at least one nitrogen atom and carbon atoms). In such a mode, the cycle characteristic of the battery tends to be even more excellent. From a similar standpoint, the number of carbon atoms in the aromatic ring structure is preferably 3 or more and 8 or less, and more preferably 4 or more and 6 or less. The aromatic ring structure is, for example, a pyrrole ring. In such a mode, the number of nitrogen atoms and the number of [—SO₂R²] groups bonded to the nitrogen atom are preferably 1 or 2, and more preferably 1. In addition, the number of nitrogen in the aromatic ring structure is, for example, 1 or 2, preferably 1.

In one mode of the compound of Formula (1), R¹ includes both the chain structure including at least one nitrogen atom and the cyclic structure including at least one nitrogen atom.

In Formula (1), R¹ may have a fluorine atom. The number of fluorine atoms in R¹ is not particularly limited, and is, for example, 0 or more and 15 or less. The number of fluorine atoms in R¹ is preferably 0 or more and 12 or less, and more preferably 0 or more and 9 or less. In such a mode, the cycle characteristic of the battery tends to be even more excellent.

In Formula (1), the number of carbon atoms in R² is not particularly limited, and is, for example, 0 or more and 10 or less. From the standpoint of further improving the cycle characteristic of the lithium secondary battery, the number of carbon atoms in R² is preferably 0 or more and 8 or less, more preferably 0 or more and 6 or less, still more preferably 0 or more and 4 or less, even more preferably 0 or more and 2 or less, and particularly preferably 0 or 1.

In Formula (1), it is preferable that R²'s are each independently a fluorine atom or an alkyl group in which a ratio (F/(F+H)) of the number (F) of fluorine atoms to the total number (F+H) of fluorine atoms and hydrogen atoms is 0.70 or more and 1.0 or less. In such a mode, the reactivity or the like of the [—SO₂R²] group is more preferable, and the cycle characteristic of the battery tend to be even more excellent. From a similar standpoint, the above-described ratio (F/(F+H)) is more preferably 0.75 or more and 1.0 or less, and still more preferably 0.80 or more and 1.0 or less.

In Formula (1), it is preferable that R²'s are each independently a fluorine atom or a trifluoromethyl group. In such a mode, the properties of the SEI layer to be formed are more suitable, and the battery tends to have even more excellent cycle characteristic.

In Formula (1), n is an integer of 1 or more and 5 or less. From the standpoint of further improving the cycle characteristic of the lithium secondary battery according to the present embodiment, n in Formula (1) is preferably 1 or more and 4 or less, more preferably 1 or more and 3 or less, and still more preferably 1 or 2.

The compound of Formula (1) according to the present embodiment is not particularly limited insofar as it is a compound represented by Formula (1), and examples thereof include compounds shown in Tables 1 and 2. From the standpoint of further improving the cycle characteristic of the lithium secondary battery, as the compound of Formula (1), it is preferable to use at least one compound of (4) to (25) in Tables 1 and 2, and it is more preferable to use at least one compound of (4) to (8), (13), or (14). In addition, one or more of the compounds of Formula (1) may be used alone or in combination.

TABLE 1

| | |
|---|---|
| 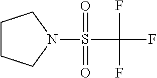 [SMILES: O=S(=O)(N1CCCC1)C(F)(F)F] | (4) |
| 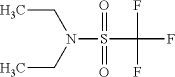 | (5) |
| 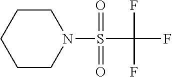 [SMILES: O=S(=O)(N1CCCCC1)C(F)(F)F] | (6) |
| 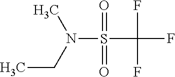 | (7) |
| 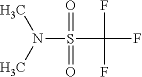 | (8) |
| 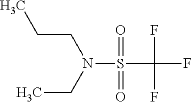 | (9) |
| 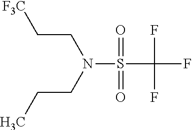 [SMILES: CCCN(CCC(F)(F)F)S(=O)(=O)C(F)(F)F] | (10) |
| 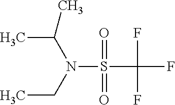 | (11) |
| 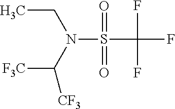 [SMILES: CCN(C(C(F)(F)F)C(F)(F)F)S(=O)(=O)C(F)(F)F] | (12) |
| 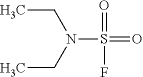 | (13) |
| 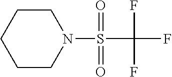 [SMILES: O=S(=O)(N1CCCCC1)C(F)(F)F] | (14) |
| 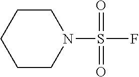 | (15) |

TABLE 2

| | |
|---|---|
| 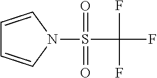 [SMILES: O=S(=O)(n1cccc1)C(F)(F)F] | (16) |
| 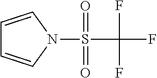 [SMILES: O=S(=O)(n1cccc1)C(F)(F)F] | (17) |
| 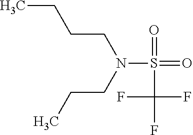 | (18) |
| 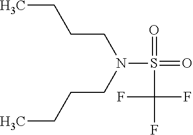 [SMILES: CCCCN(CCCC)S(=O)(=O)C(F)(F)F] | (19) |
| 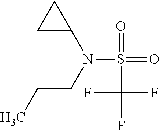 | (20) |
| 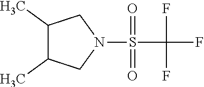 | (21) |
| 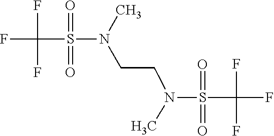 [SMILES: CN(CCN(C)S(=O)(=O)C(F)(F)F)S(=O)(=O)C(F)(F)F] | (22) |
| 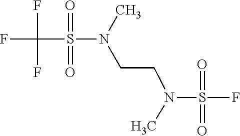 [SMILES: CN(CCN(C)S(=O)(=O)C(F)(F)F)S(=O)(=O)F] | (23) |
| 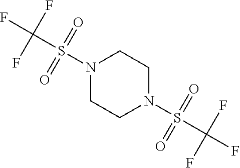 [SMILES: O=S(=O)(N1CCN(S(=O)(=O)C(F)(F)F)CC1)C(F)(F)F] | (24) |
| 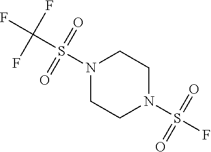 [SMILES: O=S(=O)(F)N1CCN(S(=O)(=O)C(F)(F)F)CC1] | (25) |

The electrolyte solution according to the present embodiment preferably further contains at least one chain fluorine compound represented by Formula (A) or Formula (B) (which will hereinafter be called “fluorine co-solvent”). By further containing the fluorine co-solvent in the electrolyte solution, the cycle characteristic of the lithium secondary battery tends to be further improved by the synergistic effect with the compound of Formula (1). In Formula (A), R⁶ is an alkyl group which may include an ether bond, R⁷ is a fluorine-substituted alkylene group, and R⁸ is an alkyl group which may include an ether bond. In Formula (B), R⁹ is a fluorine-substituted alkyl group, R¹⁰ is an alkylene group which may include an ether bond, and R¹¹ is an alkyl group which may be substituted with fluorine.

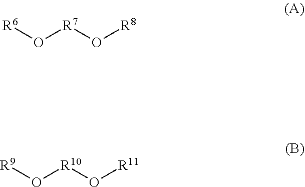

The number of carbon atoms in the fluorine co-solvent is not particularly limited, and for example, it is 3 or more and 20 or less. From the standpoint of further improving the solubility of the electrolyte in the electrolyte solution, the number of carbon atoms in the fluorine co-solvent is preferably 4 or more and 18 or less, more preferably 5 or more and 15 or less, and still more preferably 6 or more and 12 or less.

The molecular weight of the fluorine co-solvent is not particularly limited, and is, for example, 100 or more and 500 or less. From the standpoint of further improving the cycle characteristic of the lithium secondary battery, the molecular weight of the fluorine co-solvent is preferably 110 or more and 400 or less, more preferably 120 or more and 350 or less, still more preferably 130 or more and 300 or less, and even more preferably 140 or more and 250 or less.

In Formula (A), it is preferable that, in R⁷, a ratio (F/(F+H)) of the number (F) of fluorine atoms to the total number (F+H) of fluorine atoms and hydrogen atoms is 0.30 or more and 0.80 or less. In such a mode, the cycle characteristic of the battery tends to be even more excellent. In addition, from a similar standpoint, the above-described ratio (F/(F+H)) is preferably 0.40 or more and 0.75 or less, more preferably 0.45 or more and 0.70 or less, and still more preferably 0.50 or more and 0.67 or less.

In Formula (A), it is preferable that at least one of carbon atoms in R⁷, which are bonded to oxygen atoms at both terminals, does not have a fluorine atom. In a case where the fluorine co-solvent represented by Formula (A) has such a structure, the properties of the SEI layer to be formed are more suitable, and the cycle characteristic of the lithium secondary battery tends to be improved further. In addition, from a similar standpoint, in R⁷, it is more preferable that both of carbon atoms bonded to the oxygen atom do not have a fluorine atom.

The fluorine co-solvent is not particularly limited, and examples thereof include the following.

Examples of the compound represented by Formula (A) include 2,2,3,3-tetrafluoro-1,4-dimethoxybutane (TFDMB), 2,2,3,3-tetrafluoro-1,4-diethoxybutane, 1,2,2,3-tetrafluoro-1,3-dimethoxypropane, 1,1,2,2-tetrafluoro-1,2-dimethoxyethane, 2-methyl-2,3,3-trifluoro-1,4-dimethoxybutane, 2-methyl-2,3,3-trifluoro-1,4-methoxyethoxybutane, 2,3-methyl-2,3-difluoro-1,4-dimethoxybutane, 2,3-methyl-2,3-difluoro-1,4-methoxyethoxybutane, 2,2,3,3-tetrafluoromethoxyisopropoxybutane, and 2,2,3,3-tetrafluorodiisopropoxybutane.

In addition, examples of the compound represented by Formula (B) include 2,2,3,3-tetrafluoropropyl-2 (2-methoxyethoxy)ethyl ether, 1,2-bis(1,1,2,2-tetrafluoroethoxy) ethane, and 2,2,3,3-tetrafluoropropyl-2-methoxyethyl ether.

From the standpoint of improving the cycle characteristic of the lithium secondary battery, the fluorine co-solvent is preferably 2,2,3,3-tetrafluoro-1,4-dimethoxybutane (TFDMB).

In addition, the electrolyte solution according to the present embodiment may contain a compound including a fluorine atom (which will hereinafter be called “third fluorine compound”) other than the compound of Formula (1) and the fluorine co-solvent described above. That is, the electrolyte solution according to the present embodiment may contain a fluorine compound not having structures represented by Formula (1), Formula (A), and Formula (B) described above.

A content of the compound of Formula (1) in the electrolyte solution is not particularly limited.

The compound of Formula (1) may account for 100% by volume with respect to the total amount of the solvent components in the electrolyte solution, that is, the total amount of solvent components in the electrolyte solution. In a case where the entire solvent is the compound of Formula (1), phase separation of the electrolyte solution is unlikely to occur even in a case where the lithium secondary battery is repeatedly charged and discharged, and cycle stability tends to be improved further.

In addition, the content of the compound of Formula (1) is, for example, preferably 10% by volume or more, 20% by volume or more, 50% by volume or more, 70% by volume or more, 80% by volume or more, or 90% by volume or more with respect to the total amount of the solvent components in the electrolyte solution. In addition, the content of the compound of Formula (1) is preferably 100% by volume, 99% by volume or less, or 95% by volume or less. In a case where the content of the compound of Formula (1) falls within the aforesaid range, the cycle characteristic of the lithium secondary battery tends to be improved further.

A content of the fluorine co-solvent in the electrolyte solution is not particularly limited, and for example, it is 0.0% by volume or more and 95% by volume or less or 1.0% by volume or more and 90% by volume or less with respect to the total amount of the solvent components in the electrolyte solution. The content of the fluorine co-solvent is preferably 3.0% by volume or more, 5.0% by volume or more, 8.0% by volume or more, or 10% by volume or more. In addition, the content of the fluorine co-solvent is preferably 90% by volume or less, 80% by volume or less, 60% by volume or less, 50% by volume or less, 40% by volume or less, or 30% by volume or less. In a case where the content of the fluorine co-solvent falls within the aforesaid range, the cycle characteristic of the lithium secondary battery tends to be improved further.

The total content of the solvents having a fluorine atom in the electrolyte solution is not particularly limited, and for example, it is 10% by volume or more and 100% by volume or less with respect to the total amount of the solvent components in the electrolyte solution. The total content of the compounds having a fluorine atom is preferably 20% by volume or more, 30% by volume or more, 40% by volume or more, 50% by volume or more, or 60% by volume or more. In a case where the total content of the compounds having a fluorine atom is within the above-described range, the cycle characteristic of the lithium secondary battery tends to be improved further. In addition, the total content of the compounds having a fluorine atom may be 95% by volume or less, 90% by volume or less, or 85% by volume or less.

It is preferable that the electrolyte solution according to the present embodiment further contains an ether compound not having a fluorine atom (which will hereinafter be called as a “non-fluorinated ether compound”) or a carbonyl compound not having a fluorine atom (which will hereinafter be called as a “non-fluorinated carbonyl compound”). In such a mode, the solubility of the electrolyte is improved, and the battery tends to have even more excellent cycle characteristic by the synergistic effect with the compound of Formula (1). From a similar standpoint, it is more preferable that the electrolyte solution contains the ether compound not having a fluorine atom.

The number of carbon atoms in the non-fluorinated ether compound is not particularly limited, and for example, it is 2 or more and 20 or less. From the standpoint of further improving the solubility of the electrolyte in the electrolyte solution, the number of carbon atoms in the non-fluorinated ether compound is preferably 3 or more, 4 or more, 5 or more, or 6 or more. In addition, from a similar standpoint, the number of carbon atoms in the non-fluorinated ether compound is preferably 15 or less, 12 or less, 10 or less, or 9 or less.

The number of ether bonds in the non-fluorinated ether compound is not particularly limited, and for example, it is 1 or more and 10 or less. From the standpoint of further improving the solubility of the electrolyte in the electrolyte solution, the number of ether bonds in the non-fluorinated ether compound is preferably 2 or more or 3 or more. In addition, the number of ether bonds in the non-fluorinated ether compound is preferably 8 or less or 5 or less.

The non-fluorinated ether compound may be a saturated ether compound or an unsaturated ether compound. From the standpoint of further improving the cycle characteristic of the lithium secondary battery, it is preferable that the electrolyte solution contains a saturated non-fluorinated ether compound.

The non-fluorinated ether compound is not particularly limited insofar as it is an ether compound not having a fluorine atom, and examples thereof include 1,2-dimethoxyethane (DME), 1,2-dimethoxypropane (DMP), diethylene glycol dimethyl ether (DGM), triethylene glycol dimethyl ether (TGM), tetraethylene glycol dimethyl ether (TetGM), 1,3-dimethoxypropane, 1,4-dimethoxybutane, 1,1-dimethoxyethane, 2,2-dimethoxypropane, 1,3-dimethoxybutane, 1,2-dimethoxybutane, 2,2-dimethoxybutane, 2,3-dimethoxybutane, 1,2-diethoxypropane, 1,2-diethoxybutane, 2,3-diethoxybutane, and diethoxyethane. From the standpoint of further improving the solubility of the electrolyte in the electrolyte solution, the non-fluorinated ether compound is preferably selected from 1,2-dimethoxyethane (DME), 1,2-dimethoxypropane (DMP), diethylene glycol dimethyl ether (DGM), and triethylene glycol dimethyl ether (TGM).

The number of carbon atoms in the non-fluorinated carbonyl compound is not particularly limited, and for example, it is 2 or more and 20 or less. From the standpoint of further improving the solubility of the electrolyte in the electrolyte solution, the number of carbon atoms in the non-fluorinated carbonyl compound is preferably 3 or more, 4 or more, 5 or more, or 6 or more. In addition, from a similar standpoint, the number of carbon atoms in the non-fluorinated carbonyl compound is preferably 15 or less, 12 or less, 10 or less, 9 or less, or 7 or less.

The non-fluorinated carbonyl compound is not particularly limited insofar as it is a carbonyl compound not having a fluorine atom, and examples thereof include a compound having a group such as a carbonate group, a ketone group, or an ester group. From the standpoint of further improving the cycle characteristic of the battery according to the present embodiment, the non-fluorinated carbonyl compound is preferably a compound having a carbonate group and/or an ester group.

In addition, examples of such a compound include diethyl carbonate, ethyl methyl carbonate, dimethyl carbonate, ethylene carbonate, propylene carbonate, chloroethylene carbonate, methyl acetate, ethyl acetate, propyl acetate, methyl propionate, and ethyl propionate.

The total content of the non-fluorinated ether compound and the non-fluorinated carbonyl compound in the electrolyte solution according to the present embodiment is not particularly limited, and for example, it is 0.0% by volume or more and 90% by volume or less with respect to the total amount of the solvent components in the electrolyte solution. From the standpoint of further improving the cycle characteristic of the battery, the total content of the non-fluorinated ether compound and the non-fluorinated carbonyl compound is preferably 80% by volume or less, more preferably 70% by volume or less, still more preferably 60% by volume or less, and even more preferably 40% by volume or less or 20% by volume or less with respect to the total amount of the solvent components in the electrolyte solution. The total content of the non-fluorinated ether compound and the non-fluorinated carbonyl compound may be 5.0% by volume or more or 10% by volume or more with respect to the total amount of the solvent components in the electrolyte solution.

A content of the non-fluorinated ether compound in the electrolyte solution according to the present embodiment is not particularly limited, and for example, it is 0.0% by volume or more and 90% by volume or less with respect to the total amount of the solvent components in the electrolyte solution. From the standpoint of further improving the solubility of the electrolyte in the electrolyte solution, the content of the non-fluorinated ether compound is preferably 3.0% by volume or more, more preferably 5.0% by volume or more, and still more preferably 10% by volume or more with respect to the total amount of the solvent components in the electrolyte solution. In addition, from the standpoint of further improving the cycle characteristic of the battery, the content of the non-fluorinated ether compound is preferably 80% by volume or less, more preferably 50% by volume or less, still more preferably 40% by volume or less, and even more preferably 30% by volume or less or 20% by volume or less with respect to the total amount of the solvent components in the electrolyte solution.

A content of the non-fluorinated carbonyl compound in the electrolyte solution according to the present embodiment is not particularly limited, and for example, it is 0.0% by volume or more and 90% by volume or less with respect to the total amount of the solvent components in the electrolyte solution. In addition, the content of the non-fluorinated carbonyl compound may be 5.0% by volume or more or 10% by volume or more with respect to the total amount of the solvent components in the electrolyte solution. Further, the content of the non-fluorinated carbonyl compound may be 40% by volume or less, 30% by volume or less, or 20% by volume or less with respect to the total amount of the solvent components in the electrolyte solution.

As the solvent, it is sufficient that the electrolyte solution contains at least one compound represented by Formula (1) described above, and it may further contain optionally and selectively other compounds of Formula (1), the aforesaid fluorine co-solvent, the aforesaid third fluorine compound, the aforesaid non-fluorinated ether compound, the aforesaid non-fluorinated carbonyl compound, or the like in a freely combined manner. In addition, for each solvent, one or more of solvents may be used alone or in combination.

The lithium salt contained in the electrolyte solution is not particularly limited, and examples thereof include inorganic salts and organic salts of lithium. Specific examples thereof include LiI, LiCl, LiBr, LiF, LiBF₄, LiPF₆, LiPF₂O₂, LiPF₂ (C₂O₄)₂, LiPF₂ (C₃O₄)₂, LiAsF₆, LiSO₃CF₃, LiN(SO₂F)₂, LiN(SO₂CF₃)₂, LiN(SO₂CF₂CF₃)₂, LiBF₂ (C₂O₄), LiB(C₂O₄)₂, LiB(O₂C₂H₄)₂, LiB(C₃O₄)₂, LiB(O₂C₂H₄)F₂, LiB(OCOCF₃)₄, LiNO₃, and Li₂SO₄. From the standpoints of more excellent energy density and cycle characteristic of the lithium secondary battery 100, the lithium salt preferably includes at least one selected from the group consisting of LiN(SO₂F)₂ and LiN(SO₂CF₃)₂, and more preferably includes at least LiN(SO₂F)₂. One or more of the aforesaid lithium salts may be used alone or in combination.

The electrolyte solution may further contain a salt other than the lithium salt as the electrolyte. Examples of such a salt include salts of Na, K, Ca, or Mg.

The total concentration of the lithium salt in the electrolyte solution is not particularly limited, but is preferably 0.30 M or more, more preferably 0.40 M or more, still more preferably 0.50 M or more, and even more preferably 0.80 M or more. When the concentration of the lithium salt falls within the aforesaid range, the SEI layer is more easily formed and the internal resistance tends to be further reduced. In particular, in the lithium secondary battery 100 containing the fluorine compound as the solvent, the concentration of the lithium salt in the electrolyte solution can be increased, so that the cycle characteristic and rate capability can be improved further. The upper limit of the concentration of the lithium salt is not particularly limited, and the concentration of the lithium salt may be 10.0 M or less, 5.0 M or less, or 2.0 M or less.

The lithium secondary battery according to the present embodiment may contain the electrolyte solution or the components of the electrolyte solution in a state other than the liquid. For example, by adding an electrolyte solution when preparing the separator described later, a battery can be obtained in which the electrolyte solution is contained in a solid or semi-solid (gel) member. In addition, the electrolyte solution can be replaced by the electrolyte.

The molecular structure in which the electrolyte solution contains the compound of Formula (1), the fluorine co-solvent, or the like can be estimated and confirmed by performing measurement or analysis by a known method. Examples of such a method include a method using NMR, mass analysis, elemental analysis, infrared spectroscopy, and the like. In addition, the molecular structure of the solvent can be estimated by theoretical calculation using a molecular dynamics method, a molecular orbital method, and the like.

### (Separator)

The separator 130 is a member for separating the positive electrode 120 from the negative electrode 140 to prevent a short circuit of the battery and in addition, for securing the ionic conductivity of a lithium ion which serves as a charge carrier between the positive electrode 120 and the negative electrode 140. That is, the separator 130 has a function of physically and/or electrically separating the positive electrode 120 and the negative electrode 140, and a function of securing ionic conductivity of lithium ions. Therefore, the separator 130 is formed of a material that does not have electronic conductivity and does not react with lithium ions. In addition, the separator 130 may play a role of holding the electrolyte solution.

As such a separator, one member having the aforesaid two functions may be used singly, or two or more members each having the aforesaid one function may be used in combination. The separator is not particularly limited insofar as it has the aforesaid functions, and examples thereof include a porous member having insulating properties, a polymer electrolyte, a gel electrolyte, and an inorganic solid electrolyte. Typically, it is at least one selected from the group consisting of a porous member having insulating properties, a polymer electrolyte, and a gel electrolyte.

In a case where the separator includes an insulating porous member, the member exhibits ionic conductivity by filling pores of the member with a material having ionic conductivity. Examples of the material to be filled include the electrolyte solution, polymer electrolyte, and gel electrolyte described above.

As the separator 130, one or more of the insulating porous member, the polymer electrolyte, or the gel electrolyte may be used alone or in combination. In a case where the insulating porous member is used alone as the separator, the lithium secondary battery needs to further include the electrolyte solution.

A material constituting the aforesaid insulating porous member is not particularly limited, and examples thereof include an insulating polymer material, and specific examples thereof include polyethylene (PE) and polypropylene (PP). That is, the separator 130 may be a porous polyethylene (PE) film, a porous polypropylene (PP) film, or a stacked structure thereof.

The separator 130 may be covered with a separator coating layer. The separator coating layer may cover both of the surfaces of the separator 130 or may cover only one of them. From the standpoint of further improving the cycle characteristic of the lithium secondary battery according to the present embodiment, it is preferable to coat both surfaces of the separator. The separator coating layer according to the present embodiment is a uniformly continuous film-like coating layer. More specifically, the separator coating layer is a film-like coating layer which uniformly and continuously covers 50% or more, 60% or more, 70% or more, 80% or more, 90% or more, or 100% of the surface of the separator.

The separator coating layer is preferably a member being not reactive with lithium ions, and is preferably capable of firmly adhering the separator to a layer adjacent to the separator. In a case where such a coating layer is used, side reactions other than the deposition and the electrolytical dissolution of lithium ions are suppressed in the vicinity of the electrode, and the cycle characteristic of the battery tends to be improved further.

The separator coating layer preferably contains a binder. Similarly, from the standpoint of improving the adhesiveness between the separator and the layer adjacent to the separator, as the binder, it is preferable to use at least one selected from the group consisting of polyvinylidene fluoride (PVDF), ethylene-vinyl acetate copolymer (EVA), fluorine-based rubber, styrene butadiene rubber (SBR), a composite material of styrene butadiene rubber and carboxymethyl cellulose (SBR-CMC), polyacrylic acid (PAA), lithium polyacrylate (Li-PAA), polyimide (PI), polyamideimide (PAI), and aramid; and it is more preferable to use polyvinylidene fluoride (PVDF). The separator coating layer preferably contains a polymer having a fluorine atom.

In addition, in the separator coating layer, inorganic particles such as silica, alumina, titania, zirconia, yttria, ceria, magnesium oxide, zinc oxide, iron oxide, boehmite, zeolite, aluminum nitride, silicon nitride, titanium nitride, boron nitride, calcium fluoride, barium fluoride, barium sulfate, calcium carbonate, magnesium hydroxide, aluminum hydroxide, aluminum oxide hydroxide, lithium nitrate, potassium titanate, calcium silicate, and magnesium silicate may be added to the aforesaid binder. One or more of the aforesaid inorganic particles may be used alone or in combination.

An average thickness of the separator 130 including the separator coating layer is not particularly limited, and is, for example, 3.0 μm or more and 50 μm or less. The average thickness of the separator including the separator coating layer is preferably 5.0 μm or more and 30 μm or less, more preferably 7.0 μm or more and 25 μm or less, and still more preferably 10 μm or more and 20 μm or less. In a case where the average thickness falls within the aforesaid range, the separator can reliably isolate the positive electrode and the negative electrode while adjusting the volume it occupies, and the energy density and the cycle characteristic of the battery tend to be improved further.

### (Positive Electrode)

The positive electrode 120 is not particularly limited insofar as it is a positive electrode commonly used in a lithium secondary battery, and a known material can be selected as needed, depending on the use of the lithium secondary battery. From the standpoint of improving the stability and output voltage of the battery, the positive electrode 120 preferably has a positive-electrode active material.

In a case where the positive electrode has a positive-electrode active material, typically, lithium ions are filled into and extracted from the positive-electrode active material by the charge/discharge of the battery.

The term “positive-electrode active material” as used herein is a substance that causes an electrode reaction, that is, an oxidation reaction and a reduction reaction at the positive electrode. Specifically, examples of the positive-electrode active material include a host material for a lithium element (typically, lithium ions).

Such a positive-electrode active material is not particularly limited, and examples thereof include metal oxides and metal phosphates. The metal oxides are not particularly limited, and examples thereof include cobalt oxide-based compounds, manganese oxide-based compounds, and nickel oxide-based compounds. The metal phosphates are not particularly limited, and examples thereof include iron phosphate-based compounds and cobalt phosphate-based compounds. Examples of typical positive-electrode active materials include LiCoO₂, LiNiₓCo_{y}Mn_{z}O (x+y+z=1), LiNiₓCo_{y}Al_{z}O (x+y+z=1), LiNiₓMn_{y}O (x+y=1), LiNiO₂, LiMn₂O₄, LiFePO, LiCOPO, LiFeOF, LiNiOF, and LiTiS₂. From the standpoint of further improving the effect of the electrolyte solution according to the present embodiment, the positive-electrode active material is preferably a nickel oxide-based compound, more preferably at least one of LiNiₓCo_{y}Mn_{z}O (x+y+z=1), LiNiₓCo_{y}Al_{z}O (x+y+z=1), LiNiₓMn_{y}O (x+y=1), LiMSiO₄F (M=Fe, Ni, Co, or Mn), or LiNiO₂, and still more preferably LiNiₓCo_{y}Al_{z}O (x+y+z=1). One or more of the positive-electrode active materials may be used alone or in combination.

The positive electrode 120 may contain components other than the aforesaid positive-electrode active material. Such a component is not particularly limited, and examples thereof include a positive-electrode sacrificial agent, a conductive aid, a binder, a gel electrolyte, and a polymer electrolyte.

In the present embodiment, the positive-electrode sacrificial agent is a lithium-containing compound which causes an oxidation reaction and substantially does not cause a reduction reaction in a charge/discharge potential range of the positive-electrode active material. In a case where the positive electrode contains the positive-electrode sacrificial agent, lithium metal derived from the positive-electrode sacrificial agent remains on the negative electrode during the initial charge of the lithium secondary battery. In the subsequent charge, since the residual lithium metal serves as a scaffold when the lithium metal is deposited on the negative electrode, the lithium metal is likely to be uniformly deposited, and the growth of the lithium metal in a dendrite tends to be suppressed. Therefore, it is preferable that the positive electrode of the lithium secondary battery according to the present embodiment contains the positive-electrode sacrificial agent, and thus the cycle characteristic of the battery tends to be improved further. In addition, one or more of the positive-electrode sacrificial agents may be used alone or in combination.

The phrase “causing an oxidation reaction and substantially does not cause a reduction reaction” means that the reaction of releasing lithium ions proceeds and the lithium-containing compound before discharge is not formed. That is, the positive-electrode sacrificial agent undergoes the oxidation reaction and substantially does not undergo the reduction reaction in the charge/discharge potential range, so that at least some of the lithium element derived from the positive-electrode sacrificial agent remains on the negative electrode surface as lithium metal.

A compound used as the positive-electrode sacrificial agent is not particularly limited, and examples thereof include lithium oxides such as Li₂O₂; lithium nitrides such as Li₃N; lithium sulfide-based solid solutions such as Li₆MnₓCo₁₋ₓO₄ (0<x<1), Li₂S—P₂S₅, Li₂S—LiCl, Li₂S—LiBr, and Li₂S—LiI; and iron-based lithium oxides such as Li₁+x (Ti_{1-y}Fe_{y})₁₋ₓO₂ (0<x<0.25, 0.4<y≤0.9), Li₂₋ₓTi_{1-z}Fe_{z}O_{3-y} (0≤x<2, 0≤y≤1, 0.05≤z≤0.95), and Li₅FeO₄. From the standpoint of further effectively and reliably exhibiting the effect of the positive-electrode sacrificial agent, the positive-electrode sacrificial agent is preferably a lithium-containing compound containing Mn or Co, and more preferably Li₆MnₓCo₁₋ₓO₄ (0<x<1).

In addition, in a case where Li₆MnₓCo₁₋ₓO₄ (0<x<1) is used as the positive-electrode sacrificial agent, from the standpoint of further improving the cycle characteristic of the lithium secondary battery, the value of x is preferably 0.1 or more and 0.9 or less, and more preferably 0.3 or more and 0.7 or less.

The positive electrode 120 may contain a gel electrolyte, or may be a gel electrolyte. In such a mode, adhesion force between the positive electrode and the positive electrode current collector is improved by a function of the gel electrolyte, and it is possible to attach a thinner positive electrode current collector, and thus it is possible to further improve the energy density of the battery. In a case of attaching the positive electrode current collector to a surface of the positive electrode, a positive electrode current collector formed on a release paper may be used.

Examples of conductive aids that can be used in the positive electrode 120 include, but are not limited to, carbon black, single-wall carbon nanotubes (SWCNT), multi-wall carbon nanotubes (MWCNT), carbon nanofibers (CF), and acetylene black. The binder is not particularly limited, and examples thereof include polyvinylidene fluoride, polytetrafluoroethylene, styrene butadiene rubber, acrylic resins, and polyimide resins.

The content of the positive-electrode active material in the positive electrode 120 may be, for example, 50% by mass or more and 100% by mass or less based on the total amount of the positive electrode 120. From the standpoint of further improving the cycle characteristic of the lithium secondary battery according to the present embodiment, the content of the positive-electrode active material is preferably 60% by mass or more, more preferably 80% by mass or more, and still more preferably 90% by mass or more. The content of the positive-electrode sacrificial agent may be, for example, 0.5% by mass or more and 40% by mass or less based on the total amount of the positive electrode 120. From the standpoint of further improving the cycle characteristic of the lithium secondary battery, the content of the positive-electrode sacrificial agent with respect to the entire positive electrode 120 is preferably 1.0% by mass or more and 30% by mass or less, more preferably 2.0% by mass or more and 20% by mass or less, and still more preferably 3.0% by mass or more and 15% by mass or less.

The content of the conductive aid may be, for example, 0.50% by mass or more and 30% by mass or less based on the total amount of the positive electrode 120. The content of the binder may be, for example, 0.50% by mass or more and 30% by mass or less based on the total amount of the positive electrode 120. A content of the gel electrolyte or the polymer electrolyte may be, for example, 0.50% by mass or more and 30% by mass or less, and preferably 5.0% by mass or more and 20% by mass or less and more preferably 8.0% by mass or more and 15% by mass or less with respect to the entire positive electrode 120.

The content of the positive-electrode active material and the content of the positive-electrode sacrificial agent in the positive electrode 120 can be measured by a conventionally known method, and for example, can be measured by X-ray diffraction (XRD).

An average thickness of the positive electrode 120 is preferably 20 μm or more and 100 μm or less, more preferably 30 μm or more and 80 μm or less, and still more preferably 40 μm or more and 70 μm or less. However, the average thickness of the positive electrode can be appropriately adjusted according to a desired capacity of the battery.

### (Positive Electrode Current Collector)

The positive electrode current collector 110 is disposed on one side of the positive electrode 120. The positive electrode current collector is not particularly limited insofar as it is a conductor not reactive with a lithium ion in the battery. Examples of such a positive electrode current collector include aluminum. The positive electrode current collector 110 may not be provided, and in this case, the positive electrode itself acts as a current collector. The positive electrode current collector functions to transfer electrons to the positive electrode (in particular, the positive-electrode active material). The positive electrode current collector 110 is in physical and/or electrical contact with the positive electrode 120.

In the present embodiment, an average thickness of the positive electrode current collector is preferably 1.0 μm or more and 15 μm or less, more preferably 2.0 μm or more and 10 μm or less, and still more preferably 3.0 μm or more and 6.0 μm or less. In such a mode, the occupation volume of the positive electrode current collector in the lithium secondary battery 100 decreases and the resulting lithium secondary battery 100 therefore has a more improved energy density.

### (Use of Lithium Secondary Battery)

FIG. 2 shows one mode of the use of the lithium secondary battery according to the present embodiment. The lithium secondary battery 200 has a positive electrode terminal 210 and a negative electrode terminal 220 for connecting the lithium secondary battery 200 to an external circuit and these terminals are bonded to a positive electrode current collector 110 and the negative electrode 140, respectively. The lithium secondary battery 200 is charged and discharged by connecting the negative electrode terminal 220 to one end of the external circuit and the positive electrode terminal 210 to the other end of the external circuit.

The lithium secondary battery 200 is charged by applying a voltage between the positive electrode terminal 210 and the negative electrode terminal 220 to cause a current flow from the negative electrode terminal 220 (negative electrode 140) to the positive electrode terminal 210 (positive electrode 120) through the external circuit. In the lithium secondary battery 200, the solid electrolyte interphase layer (SEI layer) may be formed on the surface of the negative electrode 140 (interface between the negative electrode 140 and the separator 130), coated with the negative electrode coating agent, by a first charging (initial charging) after the battery is assembled. The SEI layer to be formed is not particularly limited, but it may contain, for example, a lithium-containing inorganic compound or a lithium-containing organic compound. The typical average thickness of the SEI layer is 1.0 nm or more and 10 μm or less.

When the positive electrode terminal 210 and the negative electrode terminal 220 are connected to the charged lithium secondary battery 200, the lithium secondary battery 200 is discharged. As a result, the deposition of the lithium metal generated on the negative electrode is electrolytically dissolved.

### (Method of Manufacturing Lithium Secondary Battery)

A method of manufacturing the lithium secondary battery 100 as illustrated in FIG. 1 is not particularly limited insofar as it can provide a lithium secondary battery equipped with the aforesaid structure and examples of the method include the method as follows.

The positive electrode current collector 110 and the positive electrode 120 are produced, for example, in the following manner. The aforesaid positive-electrode active material, conductive aid, and binder are mixed to obtain a positive electrode mixture. The mixing ratio may be, for example, 50% by mass or more and 99% by mass or less of the positive-electrode active material, 0.5% by mass or more and 30% by mass or less of the conductive aid, and 0.5% by mass or more and 30% by mass or less of the binder based on the total amount of the aforesaid positive electrode mixture. The positive electrode mixture thus obtained is applied to one of the surfaces of a metal foil (for example, Al foil) serving as a positive electrode current collector and having a predetermined thickness (for example, 5.0 μm or more and 1.0 mm or less), followed by press molding. The molded product thus obtained is punched into a predetermined size to obtain a positive electrode current collector 110 and a positive electrode 120.

Next, the negative electrode 140 in which at least a part of both surfaces or one surface is coated with the negative electrode coating agent is manufactured. First, the aforesaid negative electrode material, for example, a metal foil (for example, an electrolytic Cu foil) of 1.0 μm or more and 1.0 mm or less is washed with a solvent containing sulfamic acid. Next, after washing the negative electrode material with water, the aforesaid negative electrode material is immersed in a solution containing the negative electrode coating agent (for example, a solution in which the negative electrode coating agent is contained in an amount of 0.010% by volume or more and 10% by volume or less), and dried in the atmosphere, whereby the negative electrode material is coated with the negative electrode coating agent. In this case, by masking one surface of the negative electrode material, the negative electrode coating agent may be coated only on one surface. The negative electrode material coated with the negative electrode coating agent in this way can be punched into a predetermined size, thereby obtaining the negative electrode 140.

In the manufacturing step of the negative electrode 140, the order of the application of the negative electrode coating agent and the punching process of the negative electrode material may be reversed. That is, the negative electrode 140 may be manufactured by punching out the cleaned negative electrode material into a predetermined size and then coating the surface thereof with the negative electrode coating agent by the aforesaid method. However, according to the method of manufacturing the negative electrode in which the negative electrode material is punched out after coating with the negative electrode coating agent, the negative electrode material coated with the negative electrode coating agent can be easily manufactured by a roll-to-roll method, which is preferable.

Next, a separator 130 having the aforesaid structure is formed. As the separator 130, a separator produced by a conventionally known method or a commercially available one may be used. In addition, as a method of forming the separator coating layer, for example, the separator coating layer can be produced by applying a mixture containing the binder and the inorganic particles described above to one surface or both surfaces of the separator member.

Next, the electrolyte solution is prepared by dissolving a lithium salt in a solution obtained by mixing at least one compound of Formula (1) and optionally other compounds, using the solution as a solvent. The mixing ratio of the solvent and the lithium salt may be appropriately adjusted so that the content or concentration of each solvent and lithium salt in the electrolyte solution falls within the aforesaid ranges.

The positive electrode current collector 110 on which the positive electrode 120 is formed, the separator 130, and the negative electrode 140 coated with the negative electrode coating agent described above are laminated in this order to obtain a laminate as illustrated in FIG. 1. In a case where the negative electrode coating agent is coated on only one surface of the negative electrode 140, the laminate is laminated such that the surface faces the positive electrode 120 (and the separator 130). The laminate obtained as described above is then sealed in a sealed container together with the electrolyte solution to obtain the lithium secondary battery 100. The hermetically sealing container is not particularly limited, and examples thereof include a laminate film.

### MODIFIED EXAMPLES

The aforesaid embodiments are examples for describing the present invention. They do not intend to limit the present invention only thereto and the present invention may have various modifications without departing from the gist thereof.

For example, from the lithium secondary battery 100, the separator 130 may be omitted. In this case, it is preferable to fix the positive electrode 120 and the negative electrode 140 in a state of being sufficiently separated from each other so that the positive electrode 120 and the negative electrode 140 do not come into contact with each other physically or electrically.

In the lithium secondary battery according to the present embodiment, a current collector may be provided on the surface of the negative electrode placed so as to be in contact with the negative electrode. Such a current collector is not particularly limited, and examples thereof include those usable as a negative electrode material. When the lithium secondary battery has neither a positive electrode current collector nor a negative electrode current collector, the positive electrode or the negative electrode itself serves as a current collector.

The lithium secondary battery according to the present embodiment may have, at the positive electrode current collector and/or negative electrode, a terminal for connecting it to an external circuit. For example, a metal terminal (for example, Al, Ni, or the like) having a length of 10 μm or more and 1.0 mm or less may be bonded to one or both of the positive electrode current collector and the negative electrode. For bonding, a conventionally known method may be used and for example, ultrasonic welding is usable.

The phrase “an energy density being high” or “having a high energy density” as used herein means that the capacity of a battery per total volume or total mass is high. It is preferably 700 Wh/L or more or 300 Wh/kg or more, more preferably 800 Wh/L or more or 350 Wh/kg or more, and still more preferably 900 Wh/L or more or 400 Wh/kg or more.

The term “having an excellent cycle characteristic” as used herein means that a decreasing ratio of the capacity of a battery is small before and after the expected number of charge/discharge cycles in ordinary use. Described specifically, it means that when a first discharge capacity after the initial charge/discharge and a capacity after the number of charge/discharge cycles expected in ordinary use are compared, the capacity after charge/discharge cycles has hardly decreased compared with the first discharge capacity after the initial charge/discharge. The term “number expected in ordinary use” varies depending on the usage of the lithium secondary battery and it is, for example, 30 times, 50 times, 70 times, 100 times, 300 times, or 500 times. The phrase “capacity after charge/discharge cycles is hardly decreasing compared with the first discharge capacity after the initial charge/discharge” means, though differing depending on the usage of the lithium secondary battery, that the capacity after charge/discharge cycles is, for example, 60% or more, 65% or more, 70% or more, 75% or more, 80% or more, or 85% or more, each in the first discharge capacity after the initial charge/discharge.

A numerical range described as a preferred range or the like as used herein may be replaced with a numerical range obtained by arbitrarily combining the described upper limit value and lower limit value. For example, in a case where a certain parameter is preferably 50 or more and more preferably 60 or more, and is preferably 100 or less and more preferably 90 or less, the parameter may be any of 50 or more and 100 or less, 50 or more and 90 or less, 60 or more and 100 or less, or 60 or more and 90 or less.

### EXAMPLES

The present invention will hereinafter be described in detail by Examples and Comparative Examples. The present invention is not limited by the following test examples.

### Example 1

A lithium secondary battery of Example 1 was formed as follows.

### (Formation of Negative Electrode)

First, an electrolytic Cu foil having a thickness of 8.0 μm was washed with a solvent containing sulfamic acid, and then washed with water. Subsequently, the electrolytic Cu foil was immersed in a solution containing 1H-benzotriazole as a negative electrode coating agent, dried, and further washed with water to obtain a Cu foil coated with the negative electrode coating agent. The resulting Cu foil was punched into a predetermined size (45 mm×45 mm) to obtain a negative electrode.

### (Formation of Positive Electrode)

A positive electrode was formed. A mixture of 96 parts by mass LiNi_{0.85}Co_{0.12}Al_{0.03}O₂ positive-electrode active material, 2.0 parts by mass carbon black conductive aid, and 2.0 parts by mass polyvinylidene fluoride (PVDF) binder was applied to one surface of 12 μm-thick Al foil and press-molded. The molded product thus obtained was punched into a predetermined size (40 mm×40 mm) to obtain a positive electrode which had a positive electrode current collector on one surface.

### (Formation of Separator)

As a separator, that obtained by coating a film of 2.0-μm polyvinylidene fluoride (PVDF) on both surfaces of a 12-μm polyethylene microporous membrane and having a predetermined size (50 mm×50 mm) was formed.

### (Preparation of Electrolyte Solution)

An electrolyte solution was prepared as follows. Only the compound corresponding to the chemical formula (4) shown in Table 1 was used, and an electrolyte solution was obtained by dissolving LiN(SO₂F)₂ in the resulting mixed solution so as to have a molar concentration of 0.80 M.

### (Assembly of Battery)

The positive electrode current collector on which the positive electrode was formed, the separator, and the negative electrode obtained as described above were stacked in this order such that the positive electrode faced the separator to obtain a stacked body. Further, a 100-μm Al terminal and 100-μm Ni terminal were bonded to the positive electrode current collector and the negative electrode, respectively by ultrasonic welding and then the bonded body was inserted into a laminate-film outer container. Then, the electrolyte solution prepared as described above was injected in the outer container. The resulting outer container was sealed to obtain a lithium secondary battery.

### Examples 2 to 46

Lithium secondary batteries were obtained in the same manner as in Example 1, except that an electrolyte solution was prepared using the electrolyte, the concentration of electrolyte, and the formulation of solvents described in Tables 3 to 5. In Tables 3 to 5, (4) to (8), (13), and (14) indicating the compound of Formula (1) refer to the compounds (4) to (8), (13), and (14) described in Tables 1 and 2.

### Comparative Examples 1 and 2

Lithium secondary batteries were obtained in the same manner as in Example 1, except that an electrolyte solution was prepared using the concentration of electrolyte, and the formulation of solvents described in Table 5. That is, the batteries of Comparative Examples 1 and 2 were produced using an electrolyte solution not containing the solvent represented by Formula (1).

### Comparative Example 3

An electrolytic Cu foil having a thickness of 8.0 μm was washed with a solvent containing sulfamic acid, washed with water, and then punched into have a predetermined size (45 mm×45 mm), thereby obtaining a negative electrode of Comparative Example 3. That is, in Comparative Example 3, a lithium secondary battery was obtained in the same manner as in Example 1, except that the formulation of the electrolyte solution shown in Table 6 was used, and the negative electrode coating agent was not used.

In Tables 3 to 6, the compounds having the structures shown in Tables 1 and 2 were used as the compound represented by Formula (1). In Tables 3 to 6, “DME” represents 1,2-dimethoxyethane, “DMP” represents 1,2-dimethoxypropane, “DGM” represents diethylene glycol dimethyl ether, “TGM” represents triethylene glycol dimethyl ether, and “TFDMB” represents 2,2,3,3-tetrafluoro-1,4-dimethoxybutane. In the lithium salt, “LiFSI” represents LiN(SO₂F)₂.

In Tables 3 to 6, each solvent is classified into either the structural formula of the compound represented by Formula (1) or the co-solvent, and the content (% by volume) with respect to the total amount of the solvents is described together with the type thereof. In addition, each lithium salt is described together with its type at a concentration in terms of volume molar concentration (M (mol/L)). For example, in Example 1, it is indicated that 100% by volume of the compound corresponding to the structural formula (4) was contained as the solvent and 0.80 M of LiFSI was contained as the electrolyte.

### [Evaluation of Cycle Characteristic]

The cycle characteristic of each of the lithium secondary batteries formed in Examples and Comparative Examples was evaluated as follows.

The formed lithium secondary battery was CC-charged at 3.2 mA until the voltage reached 4.2 V (initial charge), and then CC-discharged at 3.2 mA until the voltage reached 3.0 V (which will hereinafter be called “initial discharge”). Next, a cycle of CC-charging at 13.6 mA until the voltage reached 4.2 V and then CC-discharging at 13.6 mA until the voltage reached 3.0 V was repeated at a temperature of 25° C. Tables 3 to 6 show the capacity (“initial capacity”; described as “Capacity (mAh)” in the tables) obtained from the initial discharge for each example. For the examples, the number of cycles (described as “Cycle (times)” in the tables) when the discharge capacity reached 80% of the initial capacity is shown in Tables 3 to 6.

TABLE 3

| | | Example 1 | Example 2 | Example 3 | Example 4 | Example 5 |
|---|---|---|---|---|---|---|
| Formulation | Compound of | (5): 100 | (5): 95 | (5): 90 | (5): 80 | (5): 70 |
| of electrolyte | Formula (1) | | | | | |
| solution | Co-solvent | — | DME: 5 | DME: 10 | DME: 20 | DME: 30 |
| | Lithium salt | 1.0M LIFSI | 1.0M LIFSI | 1.0M LIFSI | 1.0M LIFSI | 1.0M LIFSI |
| Characteristic | Capacity (mAh) | 55 | 62 | 69 | 68 | 64 |
| | Cycle (times) | 180 | 191 | 193 | 192 | 177 |
| | | Example 6 | Example 7 | Example 8 | Example 9 | Example 10 |
| Formulation | Compound of | (5): 50 | (5): 20 | (5): 95 | (5): 90 | (5): 80 |
| of electrolyte | Formula (1) | | | | | |
| solution | Co-solvent | DME: 50 | DME: 80 | DMP: 5 | DMP: 10 | DMP: 20 |
| | Lithium salt | 1.0M LIFSI | 1.0M LIFSI | 1.0M LIFSI | 1.0M LIFSI | 1.0M LIFSI |
| Characteristic | Capacity (mAh) | 53 | 43 | 63 | 70 | 68 |
| | Cycle (times) | 105 | 33 | 193 | 195 | 194 |

| | | Example 11 | Example 12 | Example 13 |
|---|---|---|---|---|
| Formulation | Compound of | (5): 70 | (5): 50 | (5): 20 |
| of electrolyte | Formula (1) | | | |
| solution | Co-solvent | DMP: 30 | DMP: 50 | DMP: 80 |
| | Lithium salt | 1.0M LIFSI | 1.0M LIFSI | 1.0M LIFSI |
| Characteristic | Capacity (mAh) | 66 | 55 | 46 |
| | Cycle (times) | 174 | 112 | 44 |

TABLE 4

| | | Example 14 | Example 15 | Example 16 | Example 17 | Example 18 |
|---|---|---|---|---|---|---|
| Formulation | Compound of | (4): 100 | (4): 90 | (4): 70 | (4): 90 | (4): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 58 | 69 | 63 | 68 | 63 |
| | Cycle (times) | 181 | 190 | 184 | 192 | 184 |
| | | Example 19 | Example 20 | Example 21 | Example 22 | Example 23 |
| Formulation | Compound of | (6): 100 | (6): 90 | (6): 70 | (6): 90 | (6): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 58 | 66 | 61 | 68 | 65 |
| | Cycle (times) | 168 | 178 | 168 | 181 | 172 |
| | | Example 24 | Example 25 | Example 26 | Example 27 | Example 28 |
| Formulation | Compound of | (7): 100 | (7): 90 | (7): 70 | (7): 90 | (7): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 55 | 70 | 67 | 70 | 67 |
| | Cycle (times) | 188 | 194 | 191 | 193 | 190 |
| | | Example 29 | Example 30 | Example 31 | Example 32 | Example 33 |
| Formulation | Compound of | (8): 100 | (8): 90 | (8): 70 | (8): 90 | (8): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 56 | 65 | 61 | 66 | 62 |
| | Cycle (times) | 167 | 176 | 171 | 174 | 170 |

TABLE 5

| | | Example 34 | Example 35 | Example 36 | Example 37 | Example 38 |
|---|---|---|---|---|---|---|
| Formulation | Compound of | (13): 100 | (13): 90 | (13): 70 | (13): 90 | (13): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 70 | 68 | 65 | 69 | 66 |
| | Cycle (times) | 152 | 167 | 158 | 164 | 161 |
| | | Example 39 | Example 40 | Example 41 | Example 42 | Example 43 |
| Formulation | Compound of | (14): 100 | (14): 90 | (14): 70 | (14): 90 | (14): 70 |
| of electrolyte | Formula (1) | | | | | |
| solution | Co-solvent | — | DME: 10 | DME: 30 | DMP: 10 | DMP: 30 |
| | Lithium salt | 1.0M LIFSI | 1.0M LIFSI | 1.0M LIFSI | 1.0M LIFSI | 1.0M LIFSI |
| Characteristic | Capacity (mAh) | 61 | 68 | 65 | 69 | 66 |
| | Cycle (times) | 152 | 167 | 158 | 164 | 161 |
| | | | | | Comparative | Comparative |
| | | Example 44 | Example 45 | Example 46 | Example 1 | Example 2 |
| Formulation | Compound of | (5): 90 | (5): 90 | (5): 90 | — | — |
| of electrolyte | Formula (1) | | | | | |
| solution | Co-solvent | DGM: 10 | TGM: 10 | TFDMB: 10 | DME: 100 | DMP: 100 |
| | Lithium salt | 1.0M LIFSI | 1.0M LIFSI | 1.0M LIFSI | 1.0M LIFSI | 1.0M LIFSI |
| Characteristic | Capacity (mAh) | 67 | 65 | 65 | 45 | 43 |
| | Cycle (times) | 187 | 184 | 184 | 12 | 16 |

TABLE 6

| | | Comparative |
|---|---|---|
| | | Example 3 |
| Formulation | Compound of | (5): 80 |
| of electrolyte | Formula (1) | |
| solution | Co-solvent | DMP: 20 |
| | Lithium salt | 1.0M LiFSI |
| Negative electrode coating | | Not used |
| agent | | |
| Characteristic | Capacity (mAh) | 51 |
| | Cycle (times) | 62 |

In Tables 3 to 5, “-” represents that the corresponding component was not contained.

From Tables 3 to 6, it was found that, in Examples 1 to 46 in which at least a part of the negative electrode coated with the compound containing an aromatic ring to which two or more elements selected from the group consisting of N, S, and O are each independently bonded was used and the electrolyte solution containing the compound represented by Formula (1) described above was used, the number of cycles was very high and the cycle characteristic was excellent compared to Comparative Examples.

### Example 47

As Example 47, a lithium secondary battery was produced using a positive electrode containing a positive-electrode sacrificial agent. A positive electrode was produced as follows, and the lithium secondary battery was obtained in the same manner as in Example 1 except for the positive electrode.

97 parts by mass of a mixture of the positive-electrode active material (92 parts by mass) and the positive-electrode sacrificial agent (5 parts by mass), 1.5 parts by mass carbon black conductive aid, and 1.5 parts by mass polyvinylidene fluoride (PVDF) binder was applied to one surface of 12 μm-thick Al foil as a positive electrode current collector, and press-molded. The molded product thus obtained was punched into a predetermined size to obtain a positive electrode. Here, LiNi_{0.85}Co_{0.12}Al_{0.03}O₂ was used as the positive-electrode active material, and Li₆Mn_{0.5}Co_{0.5}O₄ was used as the positive-electrode sacrificial agent.

The evaluation of the cycle characteristic of the lithium secondary battery in Example 47 was performed in the same manner as the method in Example 1. The results are shown in Table 7.

TABLE 7

| | | Examples 47 |
|---|---|---|
| Positive-electrode sacrificial | | Li₆Mn_{0.5}Co_{0.5}O₄ |
| agent | | |
| Formulation | Compound of | (5): 100 |
| of electrolyte | Formula (1) | |
| solution | Co-solvent | — |
| | Lithium salt | 1.0M LiFSI |
| Characteristic | Capacity (mAh) | 51 |
| | Cycle (times) | 220 |

From Table 7, it was found that, in Example 47 in which at least a part of the negative electrode coated with the compound containing an aromatic ring to which two or more elements selected from the group consisting of N, S, and O are each independently bonded was used, the electrolyte solution containing the compound represented by Formula (1) described above was used, and the positive electrode containing the positive-electrode sacrificial agent was further used, the number of cycles was very high and the cycle characteristic was even more excellent.

The lithium secondary battery of the present invention has a high energy density and an excellent cycle characteristic so that it has industrial applicability as a power storage device to be used for various uses.

What is claimed is:

1. A lithium secondary battery comprising:
a positive electrode;
a negative electrode not having a negative-electrode active material; and
an electrolyte solution,
wherein at least a part of a surface of the negative electrode facing the positive electrode is coated with a compound including an aromatic ring to which two or more elements selected from the group consisting of N, S, and O are each independently bonded, and
the electrolyte solution contains a lithium salt and a solvent represented by Formula (1), 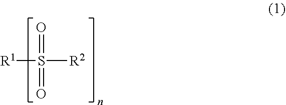
(in Formula (1), R¹ is an n-valent atomic group including at least one nitrogen atom and having 1 or more and 30 or less carbon atoms, R²'s are each independently a fluorine atom or an alkyl group having a fluorine atom, n represents an integer of 1 or more and 5 or less, and n pieces of [—SO₂R²] group are each bonded to R¹ by an N—S bond).

2. The lithium secondary battery according to claim 1,
wherein, in R¹, a nitrogen atom bonded to the [—SO₂R²] group is bonded to two carbon atoms.

3. The lithium secondary battery according to claim 1,
wherein R¹ includes a chain structure including at least one nitrogen atom.

4. The lithium secondary battery according to claim 1,
wherein R¹ includes a cyclic structure including at least one nitrogen atom.

5. The lithium secondary battery according to claim 1,
wherein R²'s are each independently a fluorine atom or an alkyl group in which a ratio (F/(F+H)) of a number (F) of fluorine atoms to a total number (F+H) of fluorine atoms and hydrogen atoms is 0.70 or more and 1.0 or less.

6. The lithium secondary battery according to claim 1,
wherein R²'s are each independently a fluorine atom or a trifluoromethyl group.

7. The lithium secondary battery according to claim 1,
wherein the electrolyte solution further contains an ether compound not having a fluorine atom or a carbonyl compound not having a fluorine atom.

8. The lithium secondary battery according to claim 1,
wherein the electrolyte solution further contains a chain fluorine compound represented by Formula (A) or Formula (B), 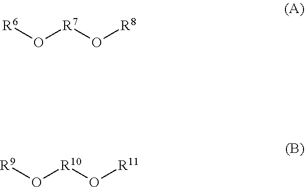
(in Formula (A), R⁶ is an alkyl group which may include an ether bond, R⁷ is a fluorine-substituted alkylene group, and R⁸ is an alkyl group which may include an ether bond, in Formula (B), R⁹ is a fluorine-substituted alkyl group, R¹⁰ is an alkylene group which may include an ether bond, and R¹¹ is an alkyl group which may be substituted with fluorine).

9. The lithium secondary battery according to claim 1,
wherein the lithium salt includes at least LiN(SO₂F)₂.

10. The lithium secondary battery according to claim 1,
wherein, in the compound coating the negative electrode, one or more nitrogen atoms are bonded to the aromatic ring.

11. The lithium secondary battery according to claim 1,
wherein the compound coating the negative electrode is at least one selected from the group consisting of benzotriazole, benzimidazole, benzimidazolethiol, benzoxazole, benzothiazolethiol, benzothiazole, mercaptobenzothiazole, polyimide, polyimidazole, and derivatives of these compounds.

12. The lithium secondary battery according to claim 1,
wherein the positive electrode contains a positive-electrode active material and a lithium-containing compound which causes an oxidation reaction and substantially does not cause a reduction reaction in a charge/discharge potential range of the positive-electrode active material.
